(19) United States
(12) Patent Application Publication
(10) Pub. No.: US 2007/0188923 A1
(43) Pub. Date: Aug. 16, 2007

(54) Vertical magnetic recording medium

(75) Inventors: Sanae Shimizu, Kawasaki (JP); Ryo Kurita, Kawasaki (JP); Toshio Sugimoto, Kawasaki (JP); Yuji Ito, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki (JP)

(21) Appl. No.: 11/442,220

(22) Filed: May 30, 2006

(30) Foreign Application Priority Data
Feb. 15, 2006 (JP) 2006-037641

(51) Int. Cl. G11B 5/82

(52) U.S. Cl. 360/135

(57) ABSTRACT

The magnetic recording medium comprises a first recording layer 16, a second recording layer 20 forming ferromagnetic coupling with the first recording layer, and an intermediate layer 18 formed between the first recording layer 16 and the second recording layer 20 and including non-magnetic layers 18a, 18b formed between the first recording layer 16 and the non-magnetic layer 18b and between the non-magnetic layer 18b and the second recording layer 20. Thus, the reproduction output of the vertical magnetic recording medium can be improved. The constitutions of the ferromagnetic layer and the non-magnetic layer of the intermediate layer are suitably controlled, whereby the S/N ratio of the vertical magnetic recording medium can be also improved.

### CROSS-REFERENCE TO RELATED APPLICATIONS

This application is based upon and claims the benefit of priority from the prior Japanese Patent Application No. 2006-037641, filed on Feb. 15, 2006, the entire contents of which are incorporated herein by reference.

### BACKGROUND OF THE INVENTION

The present invention relates to a magnetic recording medium, more specifically, a vertical magnetic recording medium for use in vertical magnetic recording.

Hard disc drives, which are magnetic recording devices, are widely used as outside storage devices of computers and various portable information terminals, e.g., mobile personal computers, game systems, digital cameras, car navigation system, etc.

Recently, the recording media of such hard disc drives, vertical magnetic recording media which can be made high coercive force by more than double in comparison with the conventional in-plane recording media are noted. The vertical magnetic recording is a magnetic recording mode forming magnetic domains formed so that adjacent recording bits are antiparallel to each other vertically to the plane of the recording media.

In the magnetic recording media for the vertical magnetic recording, the so-called “thermal fluctuation” is a problem. Thermal fluctuation is a phenomenon that when high-density recording is made, the magnetic domains are decreased, and the recorded information is erased. For suppressing the thermal fluctuation, the use of materials having high magnetic anisotropic energy Ku is effective. On the other hand, the increase of the magnetic anisotropic energy Ku increases the recording magnetic filed, and the effect is limited. It is a problem to make countermeasures for the thermal fluctuation and secured sufficient saturation recording characteristics compatible with each other.

As a countermeasure, the multi-layer structure of two or more recording layers is tried. In this, recording layers which are different in the magnetic anisotropy are stacked to thereby improve the recording characteristics. However, it is complicated and difficult to control the composition and structure of the respective layers for required magnetic characteristics. Furthermore, generally the film thickness tends to be very large, and there is a problem that the recording magnetic field from a magnetic head becomes insufficient.

In such background, a vertical magnetic recording medium which is called ECC (Exchange Coupled Composite) medium having two recording layers and a non-magnetic intermediate layer interposed between the recording layers is proposed. The ECC medium includes two magnetic layers with a non-magnetic intermediate layer formed therebetween with the axes of easy magnetization set vertical and in-plane, or obliquely to each other, and can reduces the recording magnetic field while ensuring thermal stability and suppress the side erase.

Related arts are disclosed in, e.g., Japanese published unexamined patent application No. 2001-148110.

However, the conventional ECC medium described above, the axes of easy magnetization of the recording layers are oblique to the normal direction of the substrate, which makes the signal output loss large and makes it impossible to ensure sufficient S/N ratios. Thus, vertical magnetic recording medium which can improve the reproduction output and the S/N ratio is expected.

### SUMMARY OF THE INVENTION

An object of the present invention is to provide a magnetic recording medium of the vertical magnetic recording mode which can improve the reproduction output and the S/N ratio.

According to one aspect of the present invention, there is provided a vertical magnetic recording medium comprising: a first recording layer; a second recording layer forming a ferromagnetic coupling with the first recording layer; and an intermediate layer formed between the first recording layer and the second recording layer and including a non-magnetic layer, and a ferromagnetic layer formed at least either between the first recording layer and the non-magnetic layer and between the non-magnetic layer and the second recording layer.

According to another aspect of the present invention, there is provided a magnetic recording device comprising: a vertical magnetic recording medium including: a first recording layer; a second recording layer forming a ferromagnetic coupling with the first recording layer; and an intermediate layer formed between the first recording layer and the second recording layer and including a non-magnetic layer, and a ferromagnetic layer formed at least either between the first recording layer and the non-magnetic layer and between the non-magnetic layer and the second recording layer; and a magnetic head disposed near the vertical magnetic recording medium, for recording magnetic information in a prescribed recording region of the vertical magnetic recording medium and reading magnetic information in a prescribed recording region of the vertical magnetic recording medium.

According to the present invention, in the vertical magnetic recording medium comprising the first recording layer, the second recording layer which generates the ferromagnetic coupling with the first recording layer, and the intermediate layer formed between the first recording layer and the second recording layer, the intermediate layer is formed of a non-magnetic layer and a ferromagnetic layer formed at least between the first recording layer and the non-magnetic layer or between the non-magnetic layer and the second recording layer, whereby the saturation magnetization Ms of the vertical magnetic recording layer can be improved by the ferromagnetic layer of the intermediate layer without changing the characteristics of the first recording layer and the second recording layer. Thus, the reproduction output of the vertical magnetic recording medium can be improved. The constitutions of the ferromagnetic layer and the non-magnetic layer of the intermediate layer are suitably controlled, whereby the S/N ratio of the vertical magnetic recording medium can be also improved.

The ferromagnetic layer of the intermediate layer is formed of a plurality of granules of a ferromagnetic material and a non-magnetic material filled in the grain boundaries of the granules to thereby magnetically isolate the granules by the non-magnetic material, whereby the magnetic influence on recorded information in the adjacent recording regions by the ferromagnetic layers can be more decreased in comparison with the case with the ferromagnetic layer of the intermediate layer formed continuously in plane.

### BRIEF DESCRIPTION OF THE DRAWINGS

FIG. 1 is a diagrammatic sectional view of the vertical magnetic recording medium according to a first embodiment of the present invention, which shows a structure thereof.

FIG. 2 is a graph of the non-magnetic layer thickness dependency of the squareness ratio of the vertical magnetic recording medium.

FIG. 3 is a graph of the ferromagnetic layer thickness dependency of output.

FIG. 4 is a graph of the ferromagnetic layer thickness dependency of the S/N ratio.

FIG. 5 is a graph of the coercive force change to angles of measuring the magnetic characteristics.

FIG. 6 is a graph of the ferromagnetic layer thickness dependency of output.

FIGS. 7A and 7B are diagrammatic sectional views of the vertical magnetic recording medium according to a second embodiment of the present invention, which show a structure thereof.

FIG. 8 is a graph of the ferromagnetic layer thickness dependency of the S/N ratio.

FIG. 9 is a diagrammatic view of the magnetic recording device according to a third embodiment of the present invention, which shows a structure thereof.

### DETAILED DESCRIPTION OF THE INVENTION

### A First Embodiment

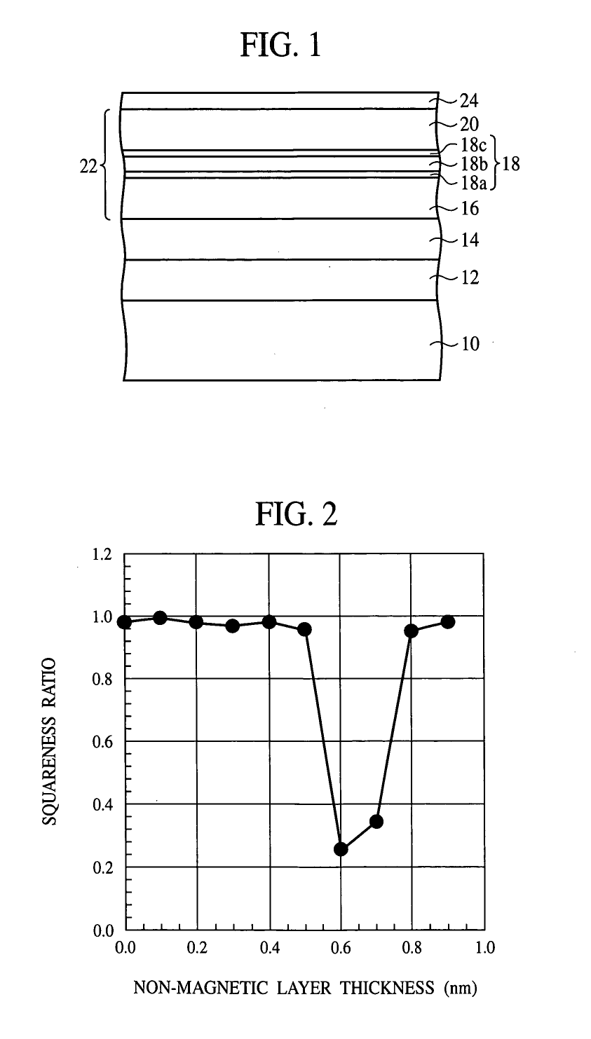

The vertical magnetic recording medium according to a first embodiment of the present invention will be explained with reference to FIGS. 1 to 6.

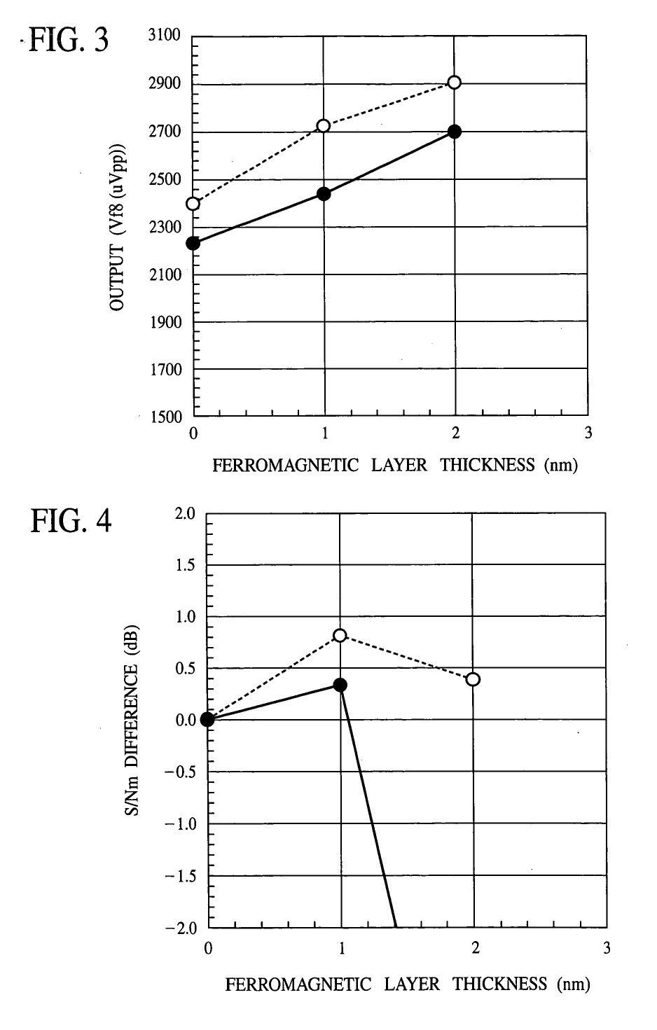

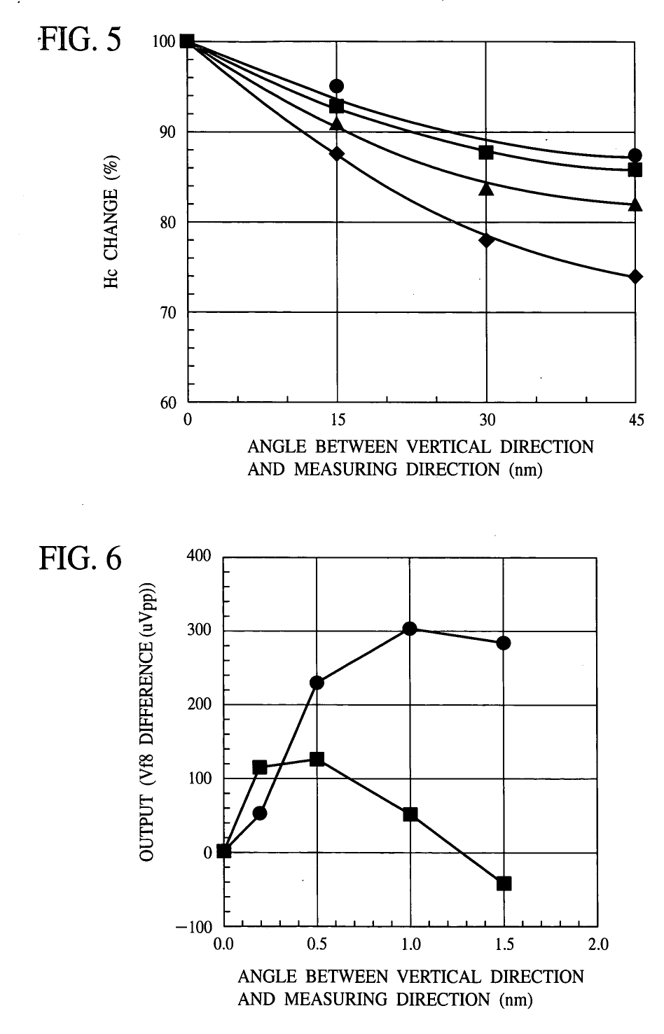

FIG. 1 shows a diagrammatic sectional view of a structure of the vertical magnetic recording medium according to the present embodiment. FIG. 2 is a graph showing the non-magnetic layer thickness dependency of the squareness ratio. FIGS. 3 and 6 are graphs showing the ferromagnetic layer thickness dependency of output. FIG. 4 is a graph showing the ferromagnetic layer thickness dependency of the S/N ratio. FIG. 5 is a graph showing changes of the coercive force for angles of the measuring direction of the magnetic characteristics.

First, the structure of the vertical magnetic recording medium according to the present embodiment will be explained with reference to FIG. 1.

A backing layer 12 of a soft magnetic material is formed on a glass substrate 10. On the backing layer 12, an intermediate layer 14 of a non-magnetic material is formed. On the intermediate layer 14 a first recording layer 16 of a ferromagnetic material is formed. On the first recording layer 16, an exchange coupling force control layer 18 is formed. The exchange coupling force control layer 18 includes a ferromagnetic layer 18a formed on the first recording layer 16, a non-magnetic layer 18b formed on the ferromagnetic layer 18a, and a ferromagnetic layer 18c formed on the non-magnetic layer 18b. On the exchange coupling force control layer 18, a second recording layer 20 of a ferromagnetic material is formed. Thus, a vertical magnetic recording layer 22 is formed of the first recording layer 16, the exchange coupling force control layer 18 and the second recording layer. On the vertical magnetic recording layer 22, a protection layer 24 is formed.

The backing layer 12 circulates a recording magnetic field generated from a recording head to form a closed circuit of the magnetic flux and is formed of a soft magnetic material, e.g., a Co-based amorphous alloy, an Ni-based alloy or others.

The intermediate layer 14 is for preventing the mutual interactions between the backing layer 12 and the vertical magnetic recording layer 22 and is formed of a non-magnetic material, e.g., Ru, Cr, Rh, Ir, their alloys or others.

The vertical magnetic recording layer 22 is for recording required magnetic information. Ferromagnetic coupling is formed between the first recording layer 16 and the second recording layer 20, and the exchange coupling force between both is controlled by the exchange coupling force control layer 18. The vertical magnetic recording layer 22 may be formed of three or more recording layers having ferromagnetic coupling with each other.

The first recording layer 16 and the second recording layer 20 have the axes of easy magnetization set vertical and in-plane with respect to the glass substrate 10, or oblique to each other. The first recording layer 16 and the second recording layer 20 are formed of ferromagnetic material, such as a CoCr-based alloy, Co-based granular materials or others, for the vertical magnetic recording. The first magnetic layer 16 and the second recording layer 20 may be formed of the same material or different materials. When they are formed of different materials, preferably the first recording layer 16, which is nearer the glass substrate 10, has larger vertical magnetic anisotropy (Ku) than the second recording layer 20, which is nearer the protection layer 24.

The magnetic layers 18a, 18c are increasing the saturation magnetization Ms of the vertical magnetic recording layer 22 and is formed of a ferromagnetic material containing, as the main component, Co, which is a high Ms ferromagnetic material, such as Co, CoCr, CoPt, CoNi, CoFe, CoNiFe or others.

The non-magnetic layer 18b plays the main role of the exchange coupling force control layer 18 controlling the exchange coupling force between the first recording layer 16 and the second recording layer, and is formed of a non-magnetic material, e.g., Ru, Cr, Rh, Ir, their alloys or others. In the specification of the present application, the exchange coupling force control layer is often called the intermediate layer.

The protection layer 24 is a layer for protecting the surface when a magnetic head scan the vertical magnetic recording medium and is formed of, e.g., carbon film or others.

Here, the vertical magnetic recording medium according to the present embodiment is mainly characterized in that the exchange coupling force control layer 18 includes the ferromagnetic layers 18a, 18c of a ferromagnetic material containing Co as the main component. The layer including a ferromagnetic material containing, as the main component, Co, which is a high Ms ferromagnetic material, is provided, whereby the saturation magnetization Ms of the vertical magnetic recording layer 22 is increased, and accordingly the reproduction output can be increased. The constitution and film thickness of the respective layers of the exchange coupling force control layer 18 are subtly controlled, whereby the S/N ratio can be also improved. The use of the layer containing, as the main component, Co, whose axes of easy magnetization are not vertical, allows the axes of easy magnetization of the first recording layer 16 and the second recording layer 20 to be changed arbitrary directions. This makes the change ratio of the coercive force Hc to angle changes lower. Both of the ferromagnetic layer 18a and the ferromagnetic layer 18c are not essentially provided, and either of the ferromagnetic layer 18a and the ferromagnetic layer 18c may be provided.

Next, the specific constitution of the respective layers forming the exchange coupling force control layer 18 will be explained with reference to FIGS. 2 to 6.

FIG. 2 is a graph of the film thickness dependency of the non-magnetic layer 18b on static magnetic characteristic squareness ratio (SQ ratio). For the measurement shown in FIG. 2, Ru film was used as the non-magnetic layer 18b.

As shown in FIG. 2, the SQ ratio is changed by changing the film thickness of the non-magnetic layer 18b. When the film thickness t of the non-magnetic layer 18b is not more than 0.5 nm and not less than 0.8 nm, the SQ ratio is substantially 1. This indicates that when the film thickness t [nm] of the non-magnetic layer 18b is 0.5<t<0.8, antiferromagnetic coupling takes place between the first recording layer 16 and the second recording layer 20 via the non-magnetic layer 18b. When the film thickness t of the non-magnetic layer 18b is t≧0.8 nm, the recording layers function independent of each other, and the effect of the exchange coupling force control layer 18 is not recognized. Accordingly, the film thickness t of the non-magnetic layer 18b must be set at t≦0.5 nm.

FIG. 3 is a graph of the dependency of the output (Vf8) on the film thickness of the ferromagnetic layers 18a, 18c. In FIG. 3, the ● marks indicate the case that the film thickness of the first recording layer 16 is 10 nm, and the ∘ marks indicate the case that the film thickness of the first recording layer 16 is 15 nm. For the measurement shown in FIG. 3, the ferromagnetic layers 18a, 18c are formed of Co film. On the horizontal axis of the graph, the respective film thicknesses of the ferromagnetic layers 18a, 18c is taken.

As shown in FIG. 3, it is seen that when the film thickness of the first recording layer 16 is 10 nm and 15 nm, the output is increased as the film thickness of the ferromagnetic layers 18a, 18b is increased. Accordingly, from the viewpoint of the output it is preferable that the film thickness of the ferromagnetic layer 18a, 18b is larger.

FIG. 4 is a graph of the dependency of the S/N ratio on the film thickness of the ferromagnetic layers 18a, 18c. On the vertical axis, values having the values of the S/N ratio given without the ferromagnetic layers 18a, 18c subtracted are taken, and the larger values indicate the higher effect of the ferromagnetic layers 18a, 18b. In the graph, the ● marks indicate the S/N ratio for the case that the film thickness of the first recording layer 16 is 10 nm, and the ∘ marks indicate the S/N ratio for the case that the film thickness of the first recording layer 16 is 15 nm. For the measurement shown in FIG. 4, the ferromagnetic layers 18a, 18c are formed of Co film, and the film thickness of the non-magnetic layer 18b is 0.4 nm. On the horizontal axis of the graph, the respective film thicknesses of the ferromagnetic layers 18a, 18b is taken.

As shown in FIG. 4, in the cases that the film thickness of the first recording layer 16 is 10 nm and 15 nm, the S/N ratio increases as the film thicknesses of the ferromagnetic layer 18a, 18b increase, reaches the peak value, and decreases when the S/N ratio exceeds the peak value. When the film thickness of the ferromagnetic layers 18a, 18b is too large, the S/N ratio is smaller than the S/N ratio given without the ferromagnetic layers 18a, 18c. The change ratio depends on the film thickness of the first recording layer 16.

Based on the result given in FIG. 4, it is preferable that when the film thickness of the first recording layer 16 is 10 nm, the film thicknesses t of the ferromagnetic layers 18a, 18c are set in the range of 0<t≦1 nm. When the film thickness of the first recording layer 16 is 15 nm, it is preferable that the film thicknesses t of the ferromagnetic layers 18a, 18c are set in the range of 0<t≦2 nm. Preferably, the film thicknesses of the ferromagnetic layers 18a, 18c are suitably set so that, for an adopted film thickness of the first recording layer 16, the S/N ratio is larger than the S/N ratio given without the ferromagnetic layers 18a, 18c.

FIG. 5 shows the changes of the coercive force Hc for the measuring direction of the magnetic characteristics. Values of the coercive force given with the coercive force as measured vertically to the film being 100% are taken on the vertical axis, and on the horizontal axis, angles between the vertical direction to the film and the measuring directions are taken. It is shown that as the coercive force change with respect to the angle change is smaller, the side erase resistance is higher. In the graph, the ♦ marks indicate the case that the ferromagnetic layers 18a, 18c are not provided. The ▴ marks indicate the case that the film thicknesses of the ferromagnetic layers 18a, 18c are 0.5 nm. The ▪ marks indicate the case that the film thicknesses of the ferromagnetic layers 18a, 18c are 1.0 nm. The ● marks indicate the case that the film thicknesses of the ferromagnetic layers 18a, 18c are 1.5 nm. In the measurement shown in FIG. 5, the ferromagnetic layers 18a, 18c are formed of Co film.

As shown in FIG. 5, it is seen that as the film thicknesses of the ferromagnetic layers 18a, 18c are larger, the change of the coercive force to the change of the angle is smaller, and the side erase resistance is high. From the viewpoint of the side erase resistance, it is preferable that the film thicknesses of the ferromagnetic layers 18a, 18b are larger.

FIG. 6 is a graph of dependency of the output on the film thickness of the ferromagnetic layer 18a or 18c when either of the ferromagnetic layers 18a, 18c is provided. On the vertical axis, values having the values of the output given without the ferromagnetic layers 18a, 18c subtracted are taken. In the graph, the ● marks indicate the case that the ferromagnetic layer 18a alone is provided. The ▪ marks indicate the case that the ferromagnetic layer 18c alone is provided. For the measurement in FIG. 6, the ferromagnetic layers 18a, 18c are formed of Co film.

As shown in FIG. 6, even with either of the ferromagnetic layers 18a, 18c, output increase is recognized. The output increase effect was higher with the ferromagnetic layer 18a alone provided than with the ferromagnetic layer 18c alone provided. With the ferromagnetic layer 18c alone provided, the output increase effect arrived at the peak at the film thickness of 0.5 nm, and the output decrease was found above the film thickness of 0.5 nm.

Based on the result given in FIG. 6, the output increase effect can be produced by providing at least one of the ferromagnetic layers 18a, 18c. The relationship between the output and the film thickness is different between the ferromagnetic layer 18a and the ferromagnetic layer 18c, and the film thickness of the ferromagnetic layer 18a and the film thickness of the ferromagnetic layer 18c may not be essentially equal to each other. It is preferable to suitably set their film thickness in view of other characteristics.

Next, the method for fabricating the vertical magnetic recording medium according to the present embodiment will be explained with reference to FIG. 1.

First, a soft magnetic material, e.g., a Co-based amorphous alloy or a Ni-based alloy is deposited in, e.g., a 50-100 nm film thickness on the glass substrate 10 by, e.g., sputtering method to form the backing layer 12.

Next, on the backing layer 12, a non-magnetic material, e.g., Ru, Cr, Rh, Ir or others is deposited in, e.g., an about 20 nm-thickness by, e.g., sputtering method to form the intermediate layer 14.

Next, on the intermediate layer 14, the first recording layer 16 of CoCrPt—SiO₂ granular material or other is formed in, e.g., an about 15 nm-thickness.

Next, on the first recording layer 16, a ferromagnetic material containing Co, e.g., Co, CoCr, CoPt, CoNi, CoFe, CoNiFe, or others is deposited in, e.g., an about 1 nm-thickness by, e.g., sputtering method to form the ferromagnetic layer 18a.

Next, on the ferromagnetic layer 18a, a non-magnetic material, e.g., Ru, Cr, Rh, Ir or others is deposited in, e.g., an about 0.5 nm-thickness by, e.g., sputtering method to form the non-magnetic layer 18b.

Next, on the non-magnetic layer 18b, a ferromagnetic material containing Co, e.g., Co, CoCr, CoPt, CoNi, CoFe, CoNiFe or others is deposited in, e.g., an about 1 nm-thickness by, e.g., sputtering method to form the ferromagnetic layer 18c.

Thus, the exchange coupling force control layer 18 is formed of the ferromagnetic layer 18a, the non magnetic layer 18b and the ferromagnetic layer 18c.

Next, on the exchange coupling force control layer 18, the second recording layer 20 of CoCrPt—SiO₂ granular material or others of, e.g., an about 5 nm-thickness is formed.

Thus, the vertical magnetic recording layer 22 of the first recording layer 16, the exchange coupling force control layer 18, and the second recording layer 18 is formed.

Next, on the vertical magnetic recording layer 22, the protection layer 24 of a carbon film of, e.g., an about 4 nm-thickness is formed.

Then, a lubricant (not shown) is applied to the protection layer 24, and the vertical magnetic recording medium according to the present embodiment is completed.

As described above, according to the present embodiment, in the vertical magnetic recording medium comprising the first recording layer, the second recording layer which generates the ferromagnetic coupling with the first recording layer, and the intermediate layer (exchange coupling force control layer) formed between the first recording layer and the second recording layer, the intermediate layer has the non-magnetic layer and the ferromagnetic layer formed at least between the first recording layer and the non-magnetic layer or between the non-magnetic layer and the second recording layer, whereby the saturation magnetization Ms of the vertical magnetic recording layer can be improved by the ferromagnetic layer of the intermediate layer without changing the characteristics of the first recording layer and the second recording layer. Thus, the reproduction output of the vertical magnetic recording medium can be improved. The constitutions of the ferromagnetic layer and the non-magnetic layer of the intermediate layer are suitably controlled, whereby the S/N ratio of the vertical magnetic recording medium can be also improved.

### A Second Embodiment

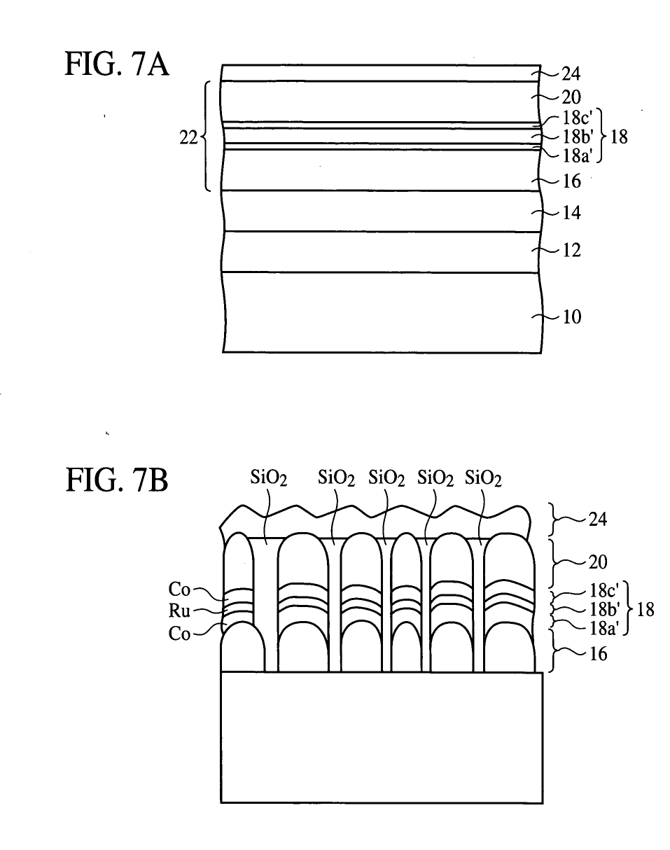

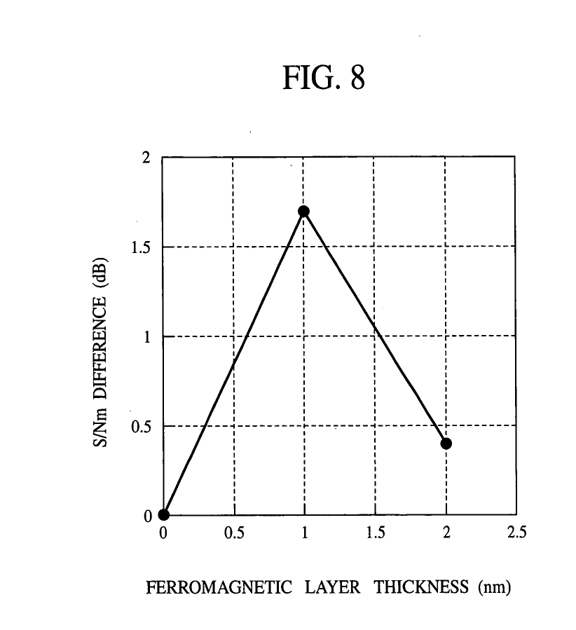

The vertical magnetic recording medium according to a second embodiment of the present invention will be explained with reference to FIGS. 7A to 8. The same members of the present embodiment as those of the vertical magnetic recording medium according to the first embodiment shown in FIG. 1 are represented by the same reference numbers not to repeat or to simplify their explanation.

FIGS. 7A and 7B are diagrammatic sectional views of the vertical magnetic recording medium according to the present embodiment, which showns a structure thereof. FIG. 8 is a graph of the ferromagnetic layer film thickness dependency of the S/N ratio.

First, the structure of the vertical magnetic recording medium according to the present embodiment will be explained with reference to FIGS. 7A and 7B. FIG. 7A is a sectional view of the vertical magnetic recording medium according to the present embodiment, which shows the general structure. FIG. 7B is an enlarged sectional view of the vertical magnetic recording medium according to the present embodiment, which details the vertical magnetic recording layer.

As shown in FIG. 7A, the basic film structure of the vertical magnetic recording medium according to the present embodiment is the same as that of the vertical magnetic recording medium according to the first embodiment shown in FIG. 1. A main characteristic of the vertical magnetic recording medium according to the present embodiment is that an exchange coupling force control layer 18 is formed of granular film.

That is, as shown in FIG. 7B, the exchange magnetic recording medium according to the present embodiment is formed of a ferromagnetic layer 18a′ formed of Co granules and SiO₂ filled in the grain boundaries and having the Co granules magnetically isolated from each other by the SiO₂, a non-magnetic layer 18b′ formed of Ru granules and SiO₂ filled in the grain boundaries and having the Ru granules isolated from each other by the SiO₂, and a ferromagnetic layer 18c′ formed of Co granules and SiO₂ filled in the grain boundaries and having the Co granules magnetically isolated from each other by the SiO₂.

The exchange coupling force control layer 18 is thus constituted, whereby the magnetic influence of the ferromagnetic layer 18a′ and the ferromagnetic layer 18c′ give to recorded information in the recording regions adjacent thereof can be decreased, and the S/N ratio can be more improved than in the first embodiment, in which the ferromagnetic layer 18a′, 18c′ are not granular.

FIG. 8 is a graph of the dependency of the ferromagnetic layer 18a′ and the ferromagnetic layer 18c′ on the S/N ratio. On the vertical axis, values having the values of the S/N ratio given without the ferromagnetic layers 18a′, 18c′ subtracted are taken, and the larger values mean that the ferromagnetic layers 18a′, 18c′ are more effective. For the measurement given in FIG. 8, the film thickness of the first recording layer 16 is 15 nm, and film thickness of the non-magnetic layer 18b′ is 0.4 nm. On the horizontal axis of the graph, the respective film thicknesses of the ferromagnetic layers 18a′, 18c′ is taken.

As shown in FIG. 8, the S/N ratio increases as the film thicknesses of the ferromagnetic layers 18a′, 18c′ increase, reaches the peak value at an about 1 nm and decreases when the S/N ratio exceed the peak value. In comparison of the peak value in FIG. 8 with the peak value of the vertical magnetic recording medium according to the first embodiment shown in FIG. 4, the S/N ratio difference could be increased about twice.

The ferromagnetic material forming the ferromagnetic layers 18a′, 18c′ can be, other than Co, CoCr, CoPt, CoNi, CoFe, CoNiFe or others.

The granules of the non-magnetic material forming the non-magnetic layer 18b′ can be, other than Ru, Cr, Rh, Ir, their alloys or others.

The material for isolating the granules of the ferromagnetic material forming the ferromagnetic layers 18a′, 18c′ and the granules of the non-magnetic material forming the non-magnetic layer 18b′ can be a non-magnetic material, an insulating material containing Si, Al, or Mg, e.g., SiO₂, e.g., SiO₂, Al₂O₃, MgO or others, or a non-magnetic metal material, such as Ag, Cr or others.

Specifically, the ferromagnetic layers 18a′, 18c′ can be formed of, e.g., Co(SiO)₅, Co(SiO)₁₀, Co(SiO)₁₅, Co(AlO₂)₅, Co(AlO₂)₁₀, Co(AlO₂)₁₅ or others, and the non-magnetic layer 18b′ can be formed of, e.g., Ru(SiO)₅, Ru(SiO)₁₀, RuCr₁₀, RuCr₁₅, Ru(MgO)₇, Ru(MgO)₁₅, Ru(MgO)₂₀, Ru(AlO₂)₅, Ru(AlO₂)₁₀, Ru(AlO₂)₁₅, Cr(MgO)₁₅, Cr(MgO)₂₀, Cr(MgO)₂₂ or others. The suffix figures of the respective materials indicate at %.

Then, the method for fabricating the vertical magnetic recording medium according to the present embodiment will be explained with reference to FIGS. 7A and 7B.

First, a soft magnetic material, e.g., a Co-based amorphous alloy or a Ni-based alloy is deposited in, e.g., an 50-100 nm-thickness on the glass substrate 10 by, e.g., sputtering method to form the backing layer 12.

Next, on the backing layer 12, a non-magnetic material, e.g., Ru, Cr, Rh, Ir or others is deposited in, e.g., a 20 nm-thickness by, e.g., sputtering method to form the intermediate layer 14.

Next, on the intermediate layer 14, the first recording layer 16 of CoCrPt—SiO₂ granular material or others is formed in, e.g., an about 15 nm-thickness.

Next, on the first recording layer 16, Co and SiO₂, for example, are sputtered, for example, to form the ferromagnetic layer 18a of, e.g., a 1 nm-thickness formed of Co granules and SiO₂ filled in the grain boundaries and having the Co granules magnetically isolated from each other by the SiO₂. At this time, the film forming gas pressure is, e.g., 0.2 Pa.

Next, on the ferromagnetic layer 18a′, Ru and SiO₂, for example, are sputtered, for example, to form the non-magnetic layer 18b′ of, e.g., a 0.4 nm-thickness formed of Ru granules and SiO₂ filed in the grain boundaries and having the Ru granules isolated from each other by the SiO₂. At this time, the film forming gas pressure is, e.g., 0.4 Pa or 0.8 Pa.

Next, on the non-magnetic layer 18b′, Co and SiO₂, for example, are sputtered, for example, to form the ferromagnetic layer 18c′ of, e.g., a 1 nm-thickness formed of Co granules and SiO₂ filled in the grain boundaries and having the. Co granules magnetically isolated from each other by the SiO₂. At this time, the film forming gas pressure is, e.g., 0.2 Pa.

Thus, the exchange coupling force control layer 18 is formed of the ferromagnetic layer 18a′, the non-magnetic layer 18b′ and the ferromagnetic layer 18c′.

Next, on the exchange coupling force control layer 18, the second recording layer 20 of, e.g., an about 5 nm-thickness and formed of CoCrPt—SiO₂ granular material or others is formed.

Thus, the vertical magnetic recording layer 22 is formed of the first recording layer 16, the exchange coupling force control layer 18 and the second recording layer 18.

Next, on the vertical magnetic recording layer 22, the protection layer 24 of a carbon film of, e.g., an about 4 nm-thickness is formed.

Then, a lubricant (not shown) is applied to the protection layer 24, and the vertical magnetic recording medium according to the present embodiment is completed.

As described above, according to the present embodiment, in the vertical magnetic recording medium comprising the first recording layer, the second recording layer which generates the ferromagnetic coupling with the first recording layer, and the intermediate layer (exchange coupling force control layer) formed between the first recording layer and the second recording layer, the intermediate layer has the non-magnetic layer and the ferromagnetic layer formed at least between the first recording layer and the non-magnetic layer or between the non-magnetic layer and the second recording layer, whereby the saturation magnetization Ms of the vertical magnetic recording layer is improved by the ferromagnetic layer of the intermediate layer without changing the characteristics of the first recording layer and the second recording layer. Thus, the reproduction output of the vertical magnetic recording medium can be improved. The constitutions of the ferromagnetic layer and the non-magnetic layer of the intermediate layer are suitably controlled, whereby the S/N ratio of the vertical magnetic recording medium can be also improved.

The ferromagnetic layer of the intermediate layer is formed of a plurality of granules of a ferromagnetic material and a non-magnetic material filled in the grain boundaries of the granules to thereby magnetically isolate the granules by the non-magnetic material, whereby the magnetic influence on recorded information in the adjacent recording regions by the ferromagnetic layers can be more decreased in comparison with the case with the ferromagnetic layer of the intermediate layer formed continuously in plane.

### A Third Embodiment

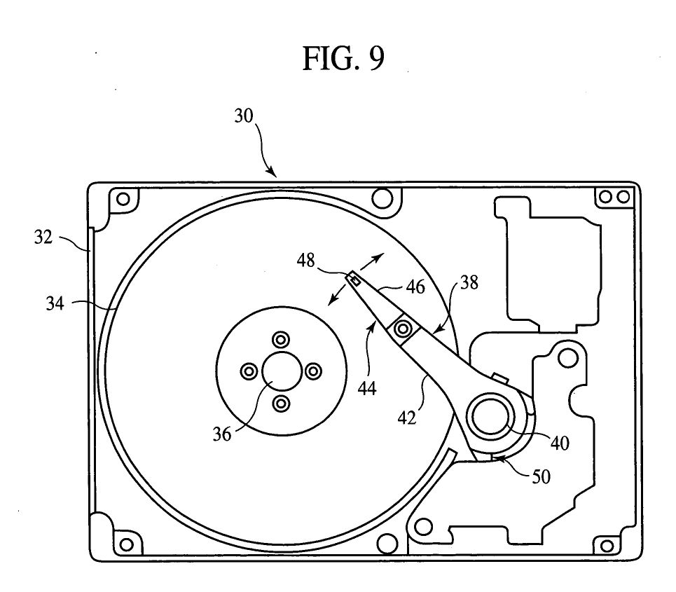

The magnetic recording device according to a third embodiment of the present invention will be explained with reference to FIG. 9.

FIG. 9 is a diagrammatic view of the magnetic recording device according to the present embodiment, which shows a structure thereof.

In the present embodiment, the magnetic recording device using the vertical magnetic recording medium according to the first or the second embodiment will be explained.

The magnetic recording device 30 according to the present embodiment includes a box body 32 defining, e.g., a lengthy cuboid interior space. The housing space accommodates one or more magnetic discs 34 as the recording media. The magnetic disc 34 is the vertical magnetic recording medium according to the first embodiment shown in FIG. 1 or the vertical magnetic recording medium according to the second embodiment shown in FIGS. 7A and 7B. The magnetic disc 34 is mounted on the rotary shaft of a spindle motor 36. The spindle motor 36 can rotate the magnetic disc 34 at a high speed of, e.g., 7200 rpm or 10000 rpm. A cover (not shown) is connected to the box body 32, for tightly closing the housing space in cooperation of the box body 32.

The housing space further accommodates a head actuator 38. The head actuator 38 is rotatably mounted on a support shaft 40 which is vertically extended. The head actuator 38 includes a plurality of actuator arms 42 horizontally extended from the support shaft 40, and head suspension assemblies 44 mounted on the forward ends of the respective actuator arms 42 and extended forward from the actuator arms 42. The actuator arms 42 are provided for the front side and the underside of the magnetic disc 34.

Each head suspension assembly 44 includes a loadbeam 46. The loadbeam 46 is connected to the forward end of the actuator arm 42 at the so-called elastically bendable area. The elastically bendable area exerts a prescribed urging force to the forward end of the loadbeam 46 toward the surface of the magnetic disc 34. A magnetic head 48 is supported on the forward end of the loadbeam 46. The magnetic head 48 is received free to change the posture by a gimbal (not shown) secured to the loadbeam 46.

When the rotation of the magnetic disc 34 generates air flow on the surface of the magnetic disc 34, the air flow causes a positive pressure, i.e., a buoyancy and a negative pressure to act on the magnetic heads 48. The buoyancy, the negative pressure and the urging force of the loadbeam 46 are balanced to keep the magnetic head 48 buoyant with relatively high rigidity during the magnetic disc 34 is rotating.

The actuator arms 42 are connected to a drive source 50, e.g., a voice coil motor (VCM). The drive source 50 rotates the actuator arms 42 on the support shaft 40. Such rotation of the actuator arms 42 permits the head suspension assembly 44 to move. When the support shaft 40 is rotated to swing the actuator arm 42 while the magnetic head 48 is buoyant, the magnetic head 48 can radially traverse the surface of the magnetic disc 34. Such movement permits the magnetic head 48 to be positioned at a required recording track on the magnetic disc 34.

The magnetic recording device is constituted to thus use the vertical magnetic recording medium according to the first or the second embodiment, whereby the reproduction output and the S/N ratio of the vertical magnetic recording medium can be improved. Thus, the characteristics and the reliability of the magnetic recording device can be improved.

### Modified Embodiments

The present invention is not limited to the above-described embodiments and can cover other various modifications.

For example, in the first and the second embodiments described above, the exchange coupling control layer 18 has the three-layer structure of the ferromagnetic layer/the non-magnetic layer/the ferromagnetic layer but may have the two-layer structure of the ferromagnetic layer/the non-magnetic layer or the non-magnetic layer/the ferromagnetic layer. Layers different from the above-described ferromagnetic layers and the non-magnetic layer may be further included.

In the first and the second embodiment described above, the first recording layer and the second recording layer 20 are formed of granular material but may be formed of recording layer materials of a non-granular material, such as CoCrPt or others.

The constitutions of the backing layer 12, the intermediate layer 14 and the protection layer 24 are not have essentially as described above in the above-described embodiments and can be suitably changed corresponding to required characteristics, etc. of the vertical magnetic recording medium.

What is claimed is:

1. A vertical magnetic recording medium comprising:
a first recording layer;
a second recording layer forming a ferromagnetic coupling with the first recording layer; and
an intermediate layer formed between the first recording layer and the second recording layer and including a non-magnetic layer, and a ferromagnetic layer formed at least either between the first recording layer and the non-magnetic layer and between the non-magnetic layer and the second recording layer.

2. A vertical magnetic recording medium according to claim 1, wherein
the ferromagnetic layer includes a plurality of granules of a ferromagnetic material and a non-magnetic material filled in grain boundaries of the granules,
the granules are magnetically isolated from each other by the non-magnetic material.

3. A vertical magnetic recording medium according to claim 2, wherein
the no-magnetic layer includes a plurality of granules of a non-magnetic material and an another non-magnetic material filled in grain boundaries of the granules,
the granules are isolated from each other by said another non-magnetic material.

4. A vertical magnetic recording medium according to claim 3, wherein
said another non-magnetic material is an insulating material containing Si, Al or Mg, Ag or Cr.

5. A vertical magnetic recording medium according to claim 1, wherein
the ferromagnetic material forming the ferromagnetic layer is Co or an alloy of Co as an main component.

6. A vertical magnetic recording medium according to claim 1, wherein
the non-magnetic material forming the non-magnetic layer is Ru, Cr, Rh, Ir or their alloys.

7. A vertical magnetic recording medium according to claim 1, wherein
the non-magnetic layer has a film thickness of not more than 0.5 nm.

8. A vertical magnetic recording medium according to claim 1, wherein
the ferromagnetic layer has a film thickness of not more than 2 nm.

9. A vertical magnetic recording medium according to claim 1, wherein
the ferromagnetic layer has a film thickness of not more than 1 nm.

10. A magnetic recording device comprising:
a vertical magnetic recording medium including:
a first recording layer;
a second recording layer forming a ferromagnetic coupling with the first recording layer; and
an intermediate layer formed between the first recording layer and the second recording layer and including a non-magnetic layer, and a ferromagnetic layer formed at least either between the first recording layer and the non-magnetic layer and between the non-magnetic layer and the second recording layer; and
a magnetic head disposed near the vertical magnetic recording medium, for recording magnetic information in a prescribed recording region of the vertical magnetic recording medium and reading magnetic information in a prescribed recording region of the vertical magnetic recording medium.
